(19) United States
(12) Patent Application Publication
(10) Pub. No.: US 2014/0152747 A1
(43) Pub. Date: Jun. 5, 2014

(54) INKJET PRINT HEAD

(71) Applicant: SAMSUNG ELECTRO-MECHANICS CO., LTD., Suwon (KR)

(72) Inventors: Jae Chang LEE, Suwon (KR); Hwa Sun Lee, Suwon (KR); Tae Kyung Lee, Suwon (KR); Byung Hun Kim, Suwon (KR); Sung Wook Kim, Suwon (KR)

(73) Assignee: SAMSUNG ELECTRO-MECHANICS CO., LTD., Suwon (KR)

(21) Appl. No.: 13/772,612

(22) Filed: Feb. 21, 2013

(30) Foreign Application Priority Data
Dec. 5, 2012 (KR) 10-2012-0140578

(51) Int. Cl. B41J 2/175

(52) U.S. Cl. CPC B41J 2/17563
USPC 347/93

(57) ABSTRACT

There is provided an inkjet print head having a stable filter structure. The inkjet print head includes a vibration substrate including a first filter formed therein; and a channel forming substrate including a second filter and a pressure chamber formed therein, the second filter being connected to the first filter.

### CROSS-REFERENCE TO RELATED APPLICATIONS

This application claims the priority of Korean Patent Application No. 10-2012-0140578 filed on Dec. 5, 2012, in the Korean Intellectual Property Office, the disclosure of which is incorporated herein by reference.

### BACKGROUND OF THE INVENTION

1. Field of the Invention

The present invention relates to an inkjet print head, and more particularly, to an inkjet print head including a filter having a stable structure.

2. Description of the Related Art

An inkjet print head has been widely used commercially and industrially. In addition, as a range of usage of inkjet print heads has gradually expanded, performance of inkjet print heads has also gradually improved.

For example, the inkjet print head may include a filter for filtering foreign objects contained ink. The above-mentioned filter is installed in a vibration substrate so as to remove foreign objects contained in ink supplied from an ink tank to the inkjet print head.

However, as inkjet print heads have been thinned in recent times, it is difficult to form a filter in the inkjet print head (particularly, in a vibration substrate).

Meanwhile, related art examples of inkjet print heads including filters formed therein are disclosed in Patent Documents 1 and 2. Here, Patent Document 1 discloses that a channel unit 30 is provided with a filter part 120, and Patent Document 2 discloses that an ink supply hole 130 is provided with a membrane filter structure 16. However, since the filter part 120 of the Patent Document 1 is formed in a punching process, it may be difficult to be applicable to a thinned inkjet print head, and since the filter structure 16 of Patent Document 2 may not have sufficient strength, it may be easily damaged by external impacts.

Therefore, development of an inkjet print head that can be formed through a general manufacturing process for a general inkjet print head and that has a stable filter structure has been urgently demanded.

### RELATED ART DOCUMENTS

(Patent Document 1) JP2009-101643 A
(Patent Document 2) JP2005-178364 A

### SUMMARY OF THE INVENTION

An aspect of the present invention provides an inkjet print head including a filter having a stable structure, not easily damaged by external impacts.

According to an aspect of the present invention, there is provided an inkjet print head, including: a vibration substrate including a first filter formed therein; and a channel forming substrate including a second filter and a pressure chamber formed therein, the second filter being connected to the first filter.

The first filter and the second filter may have the same shape.

The first filter may include a plurality of first grooves extended to be elongated in a first direction, and the second filter may include a plurality of second grooves extended to be elongated in a second direction.

The plurality of first grooves and the plurality of second grooves may be disposed to intersect one another.

The first filter may include a plurality of first holes having a first size, and the second filter may include a plurality of second holes having a second size.

The vibration substrate may have a thickness of 1.3 μm or less.

The inkjet print head may further include a nozzle forming substrate including a restrictor and a nozzle formed therein, wherein the restrictor may connect the first filter and the pressure chamber, and the nozzle may be connected to the pressure chamber.

According to another aspect of the present invention, there is provided an inkjet print head, including: a vibration substrate including a first filter formed therein; a first channel forming substrate including a second filter formed therein, the second filter being connected to the first filter; and a second channel forming substrate including a third filter formed therein, the third filter being connected to the second filter.

At least one pair of the first filter, the second filter, and the third filter may have the same shape.

The first filter, the second filter, and the third filter may have different shapes from each other.

The first filter may include a plurality of first grooves extended to be elongated in a first direction, and the second filter may include a plurality of second grooves extended to be elongated in a second direction.

The plurality of first grooves and the plurality of second grooves may be disposed to intersect one another.

The third filter may include a plurality of third grooves extended to be elongated in the first direction.

The third filter may include a plurality of third grooves extended to be elongated in a third direction.

The first filter may include a plurality of first holes having a first size, the second filter may include a plurality of second holes having a second size, and the third filter may include a plurality of third holes having a third size.

The first holes, the second holes and the third holes may have different sizes.

The vibration substrate may have a thickness of 1.3 μm or less.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partially cut-away perspective view showing an inkjet print head according to a first embodiment of the present invention;

FIG. 2 is a plan view of a vibration substrate shown in FIG. 1;

FIG. 3 is a plan view of a channel forming substrate shown in FIG. 1;

FIG. 4 is a partially cut-away perspective view showing an inkjet print head according to a second embodiment of the present invention;

FIG. 5 is a plan view of a vibration substrate shown in FIG. 4;

FIG. 6 is a plan view of a channel forming substrate shown in FIG. 4;

FIG. 7 is a partially cut-away perspective view showing an inkjet print head according to a third embodiment of the present invention;

FIG. 8 is a plan view of a vibration substrate shown in FIG. 7;

FIG. 9 is a plan view of a channel forming substrate shown in FIG. 7;

FIG. 10 is a partially cut-away perspective view showing an inkjet print head according to a fourth embodiment of the present invention;

FIG. 11 is a plan view of a vibration substrate shown in FIG. 10;

FIG. 12 is a plan view of a first channel forming substrate shown in FIG. 10;

FIG. 13 is a plan view of a second channel forming substrate shown in FIG. 10;

FIG. 14 is a partially cut-away perspective view showing an inkjet print head according to a fifth embodiment of the present invention;

FIG. 15 is a plan view of a vibration substrate shown in FIG. 14;

FIG. 16 is a plan view of a first channel forming substrate shown in FIG. 14; and

FIG. 17 is a plan view of a second channel forming substrate shown in FIG. 14.

### DETAILED DESCRIPTION OF THE EMBODIMENTS

Hereinafter, embodiments of the present invention will be described in detail with reference to the accompanying drawings.

The invention may, however, be embodied in many different forms and should not be construed as being limited to the embodiments set forth herein. Rather, these embodiments are provided so that this disclosure will be thorough and complete, and will fully convey the scope of the invention to those skilled in the art.

In the drawings, the shapes and dimensions of components may be exaggerated for clarity, and the same reference numerals will be used throughout to designate the same or like components.

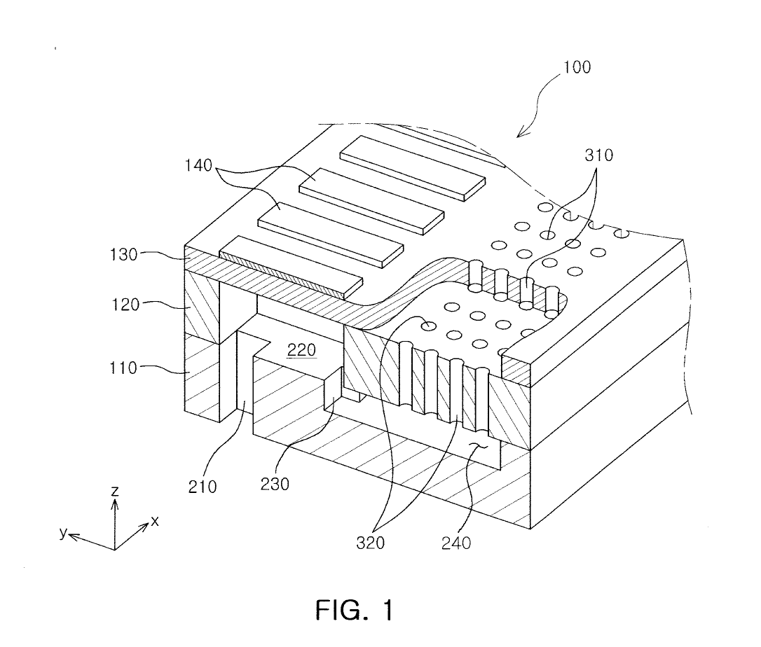

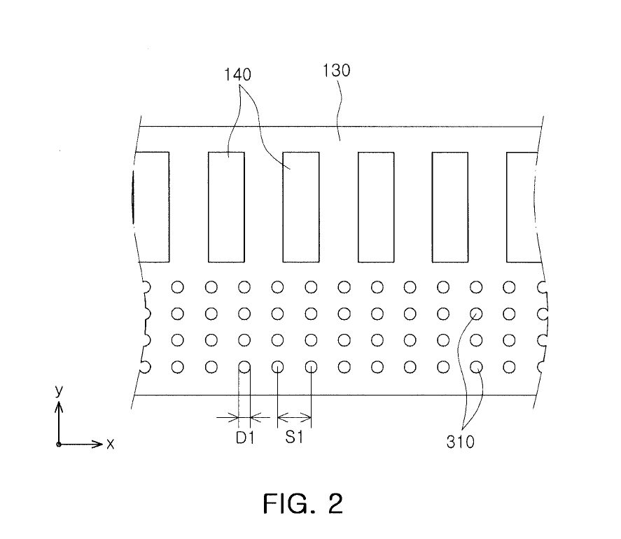

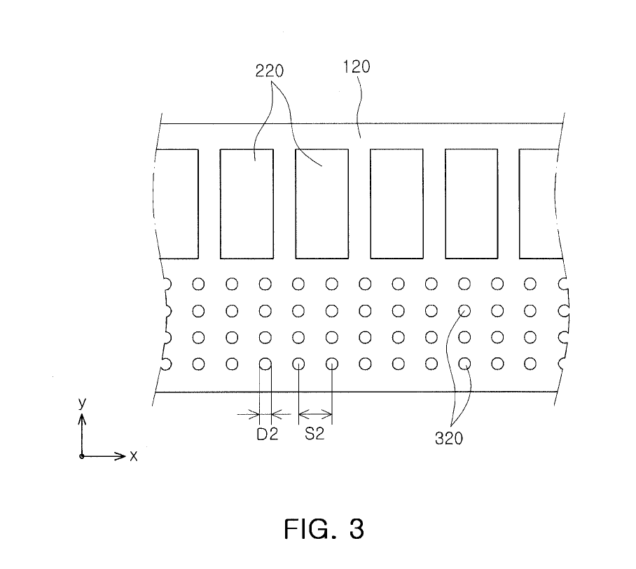

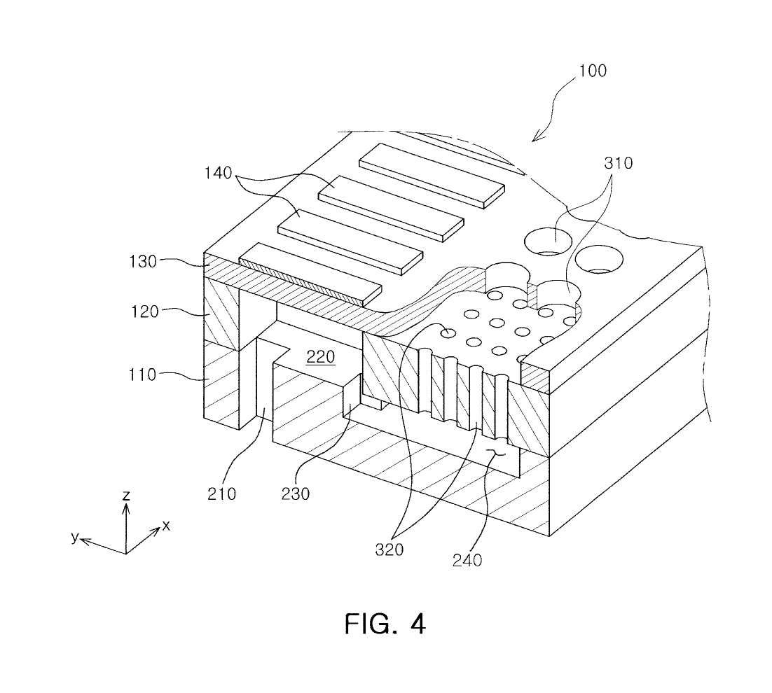

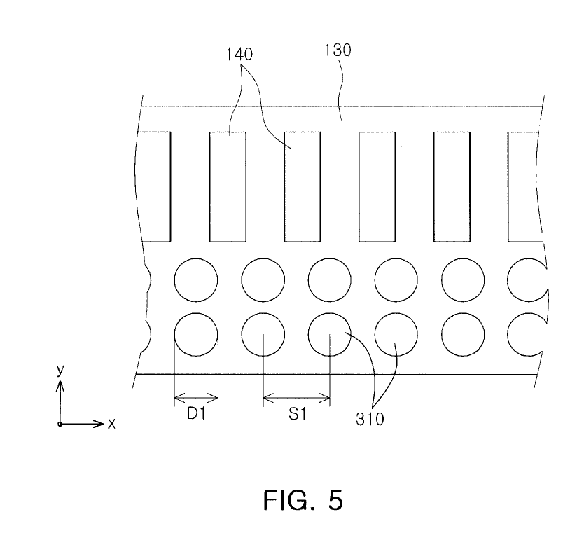

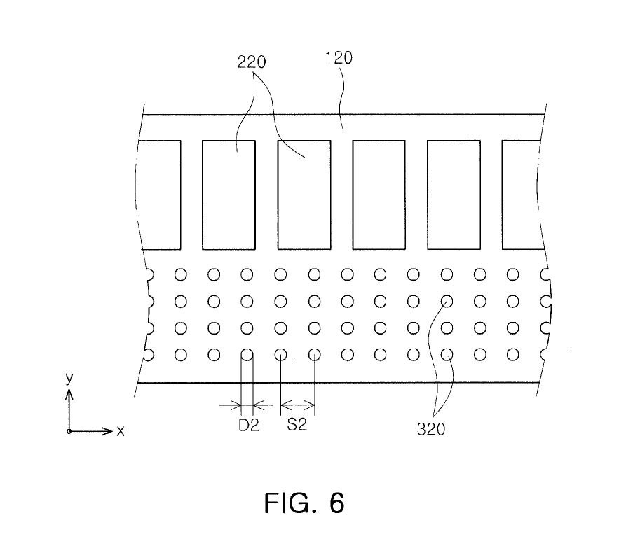

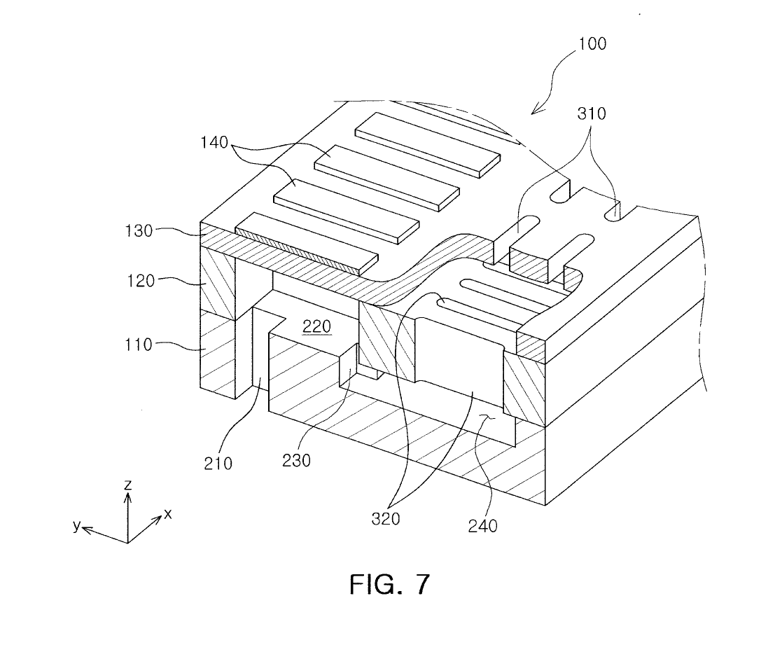

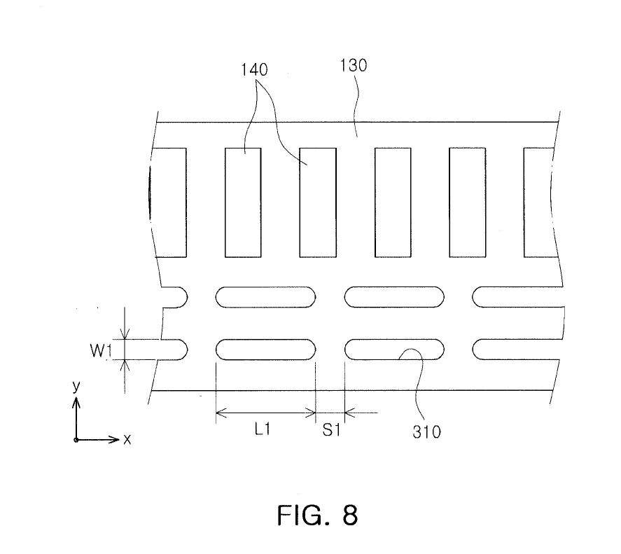

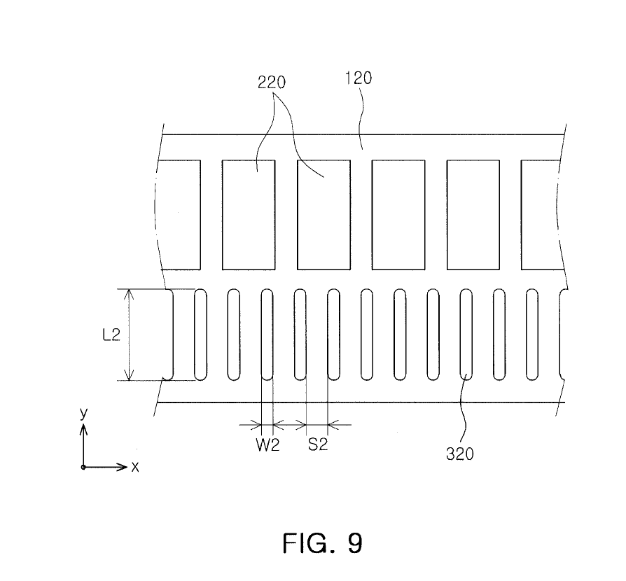

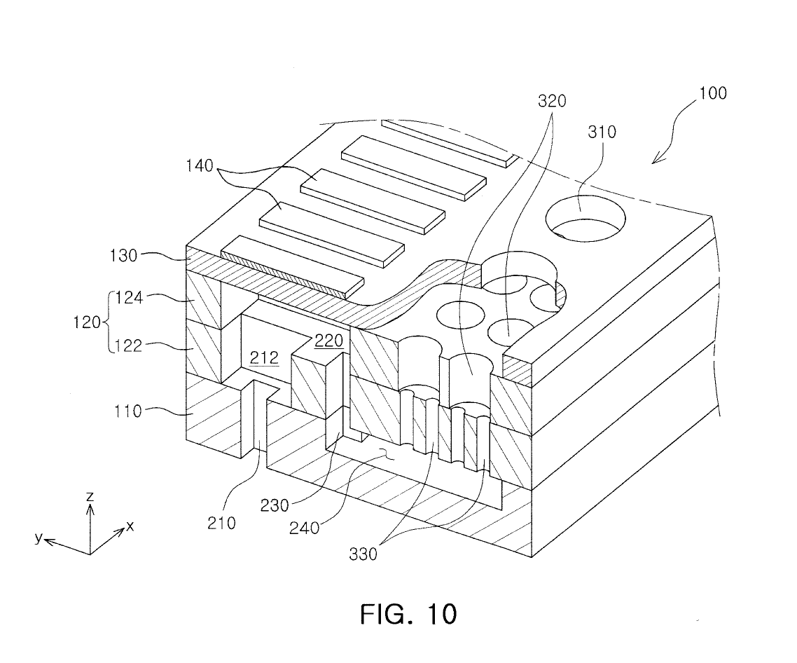

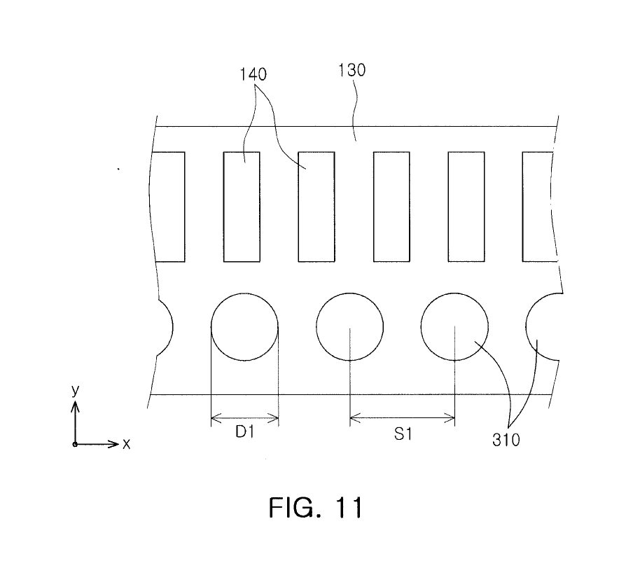

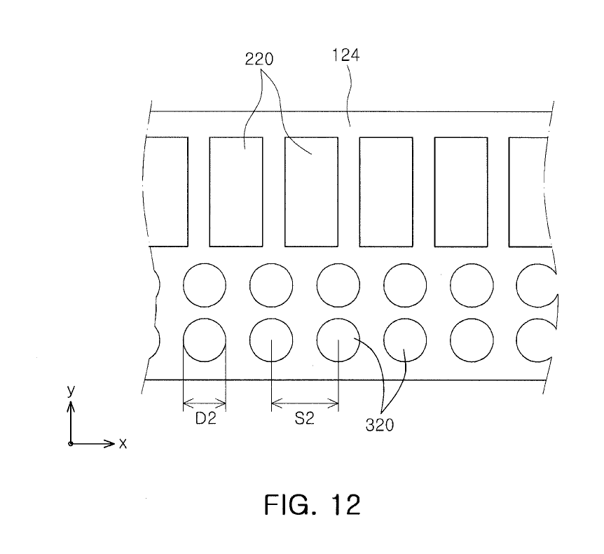

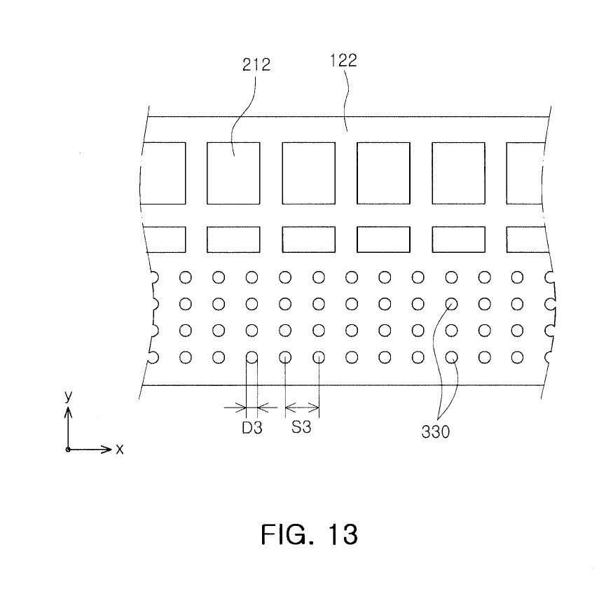

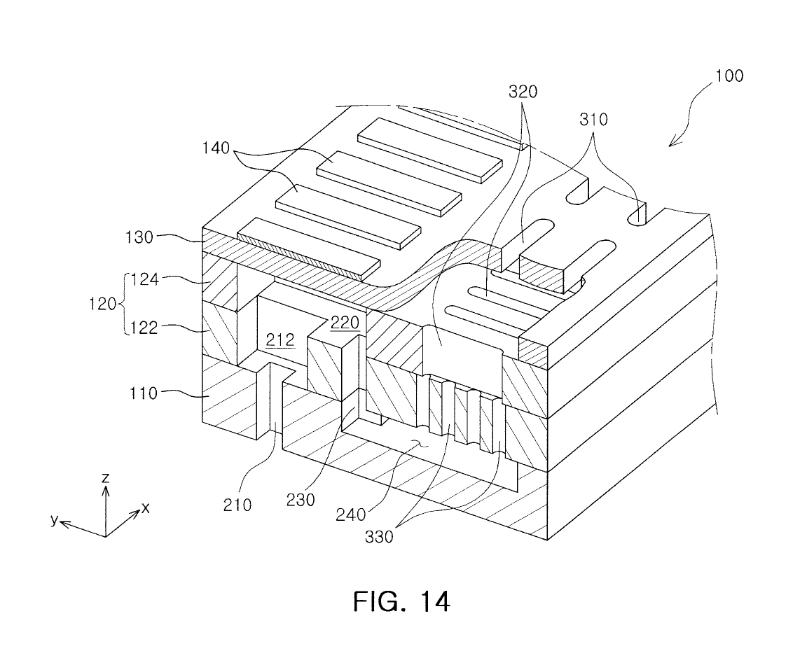

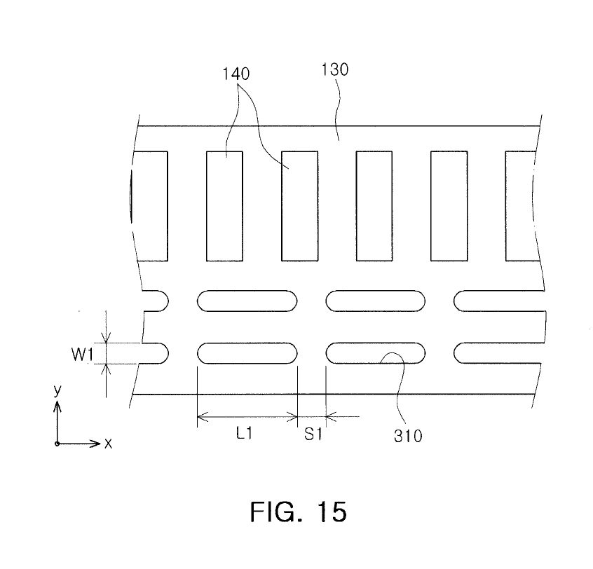

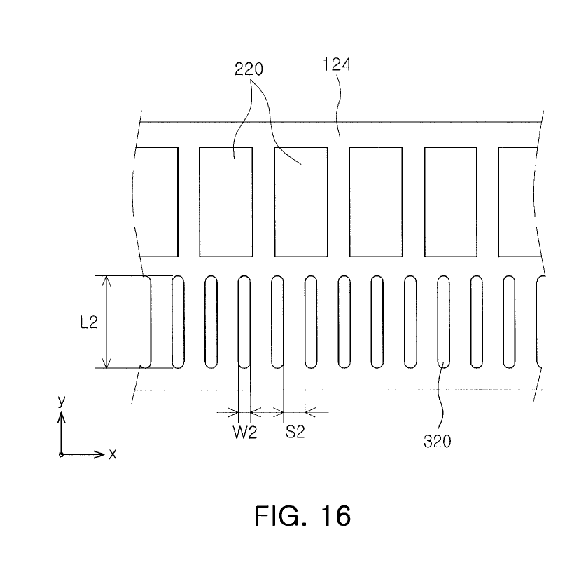

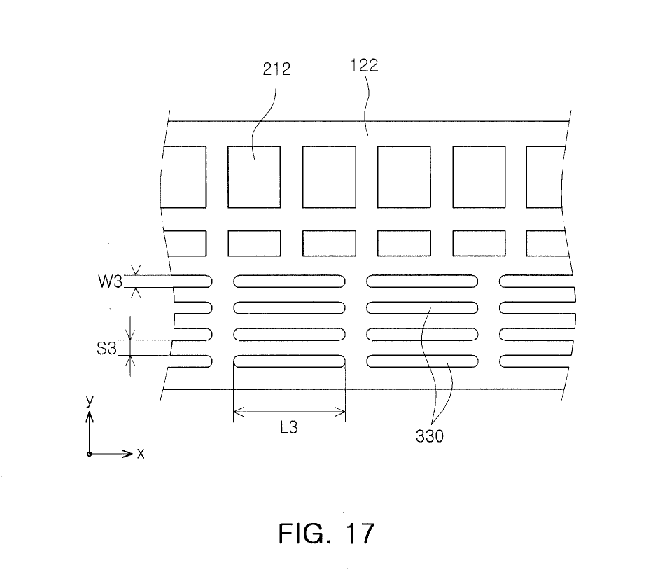

FIG. 1 is a partially cut-away perspective view showing an inkjet print head according to a first embodiment of the present invention, FIG. 2 is a plan view of a vibration substrate shown in FIG. 1, FIG. 3 is a plan view of a channel forming substrate shown in FIG. 1, FIG. 4 is a partially cut-away perspective view showing an inkjet print head according to a second embodiment of the present invention, FIG. 5 is a plan view of a vibration substrate shown in FIG. 4, FIG. 6 is a plan view of a channel forming substrate shown in FIG. 4, FIG. 7 is a partially cut-away perspective view showing an inkjet print head according to a third embodiment of the present invention, FIG. 8 is a plan view of a vibration substrate shown in FIG. 7, FIG. 9 is a plan view of a channel forming substrate shown in FIG. 7, FIG. 10 is a partially cut-away perspective view showing an inkjet print head according to a fourth embodiment of the present invention, FIG. 11 is a plan view of a vibration substrate shown in FIG. 10, FIG. 12 is a plan view of a channel forming substrate shown in FIG. 10, FIG. 13 is a plan view of a second channel forming substrate shown in FIG. 10, FIG. 14 is a partially cut-away perspective view showing an inkjet print head according to a fifth embodiment of the present invention, FIG. 15 is a plan view of a vibration substrate shown in FIG. 14, FIG. 16 is a plan view of a first channel forming substrate shown in FIG. 14, and FIG. 17 is a plan view of a second channel forming substrate shown in FIG. 14.

An inkjet print head according to a first embodiment of the present invention will be described with reference to FIGS. 1 through 3.

An inkjet print head 100 may include a nozzle forming substrate 110, a channel forming substrate 120, a vibration substrate 130, and an actuator 140. In addition, the inkjet print head 100 may further include a first filter 310 and a second filter 320. Here, the nozzle forming substrate 110, the channel forming substrate 120, and the vibration substrate 130 may be sequentially stacked in a vertical direction (a Z axis direction based on FIG. 1).

The nozzle forming substrate 110 may be formed of a monocrystal silicon substrate. However, the nozzle forming substrate 110 may be formed of a silicon on insulator (SOI) substrate, as needed. In this case, the nozzle forming substrate 110 may be a stack structure in which a silicon substrate and a plurality of insulating members are stacked.

The nozzle forming substrate 110 may be provided with a plurality of nozzles 210. More specifically, the nozzle 210 may completely penetrate through the nozzle forming substrate 110 in a vertical direction. That is, the nozzle 210 may have a depth equal to or smaller than a thickness of the nozzle forming substrate 110. The nozzle 210 may have the same cross-sectional diameter in a thickness direction of the nozzle forming substrate 110 as shown in FIG. 1. However, the nozzle 210 does not necessarily have the same cross-sectional diameter in the thickness direction of the nozzle forming substrate 110. For example, the nozzle 210 may have a cross-sectional diameter, gradually reduced toward a lower surface of the nozzle forming substrate 110 from an upper surface thereof. The nozzles 210 formed as described above may be formed to be spaced apart from each other by an interval in one direction (an x-axis direction based on FIG. 1) of the nozzle forming substrate 110.

The nozzle forming substrate 110 may be further provided with a restrictor 230 and a manifold 240. The restrictor 230 may be formed at a predetermined depth and may be connected to a pressure chamber 220 as shown in FIG. 1. Meanwhile, although the present embodiment shows a case in which the restrictor 230 is formed in the nozzle forming substrate 110, the restrictor 230 may be formed in the nozzle forming substrate 120, as needed.

The manifold 240 may be connected to the pressure chamber 220 through the restrictor 230. The manifold 240 may be formed to be elongated in a length direction (an X axis direction based on FIG. 1) of the channel forming substrate 120. That is, the manifold 240 may be formed as a single body in the length direction of the channel forming substrate 120 to thereby be simultaneously connected to the plurality of pressure chambers 220. Although not shown in the drawings, the manifold 240 may be connected to an ink supply tank. Therefore, ink in the ink supply tank may be supplied to the respective pressure chambers 220 through the manifold 240.

The channel forming substrate 120 may be formed of a monocrystal silicon substrate similar to the nozzle forming substrate 110. However, the channel forming substrate 120 may be formed of a silicon on insulator (SOI) substrate, as needed. In this case, the channel forming substrate 120 may be a stack structure in which a silicon substrate and a plurality of insulating members are stacked. The channel forming substrate 120 configured as described above may be formed on one surface (an upper surface) of the nozzle forming substrate 110.

The channel forming substrate 120 may be provided with the pressure chamber 220 and the second filter 320.

The pressure chamber 220 may have a predetermined volume. More specifically, the pressure chamber 220 may have a volume equal to or greater than that of the ink which may be discharged by one time operation of the actuator 140. Here, the former may be advantageous for discharging a fixed quantity of ink and the latter may be advantageous for continuously discharging ink from the inkjet print head 100.

The second filter 320 may be connected to the manifold 240 and may include a plurality of second holes. For example, the second filter 320 may include the plurality of second holes spaced apart from each other by a predetermined interval in a first direction (an X axis direction based on FIG. 1) and a second direction (a Y axis direction based on FIG. 1) of the channel forming substrate 120. The second filter 320 configured as described above may remove or alleviate the amount of foreign objects contained in the ink.

The vibration substrate 130 may be formed on the channel forming substrate 120. More specifically, the vibration substrate 130 may be formed on one surface (an upper surface) of the channel forming substrate 120. The vibration substrate 130 configured as described above may deliver driving force generated by the actuator 140 to the pressure chamber 220. Meanwhile, the vibration substrate 130 may have a thickness (or a height) of 1.3 μm or less. As described above, in the case in which the thickness of the vibration substrate 130 is changed to 1.3 μm or less, even when the height of the actuator 140 becomes lower, the driving force of the actuator 140 may be efficiently delivered to the pressure chamber 220. Therefore, the entire height of the inkjet print head 100 may be significantly decreased, whereby the miniaturization and the thinning of the inkjet print head 100 may be achieved.

The vibration substrate 130 may be provided with the first filter 310. Here, the first filter 310 may include a plurality of first holes. For example, the first filter 310 may include the plurality of first holes spaced apart from each other by a predetermined interval in a first direction (an X axis direction based on FIG. 1) and a second direction (a Y axis direction based on FIG. 1) of the vibration substrate 310. The first filter 310 configured as described above may remove or alleviate the amount of foreign objects contained in the ink.

The first filter 310 may be connected to the second filter 320. Here, a size D1 of the hole included in the first filter 310 may be the same as a size D2 of the hole included in the second filter 320. In addition, an interval S1 between the holes included in the first filter 310 may be the same as an interval S2 between the holes included in the second filter 320. That is, the first filter 310 and the second filter 320 may have the same shape. Therefore, according to the present embodiment, even when the vibration substrate 130, a base material of the first filter 310 has a thin thickness, the strength of the first filter 310 may be reinforced by the second filter 320 of the channel forming substrate 120.

The actuator 140 may be formed on the vibration substrate 130. The actuator 140 may have a size corresponding to a length (a length in a Y axis direction) and a width (a length in an X axis direction) of the pressure chamber 220. More specifically, a length of the actuator 140 may be the same as the length of the pressure chamber 220 and a width of the actuator 140 may be the same as the width of the pressure chamber 220. However, in order to easily make connection between the actuator 140 and electrodes, the length and the width of the actuator 140 may be greater than the length and the width of the pressure chamber 220.

The actuator 140 may include a lower electrode, a piezoelectric element, and an upper electrode. The lower electrode may be formed on the vibration substrate 130. The piezoelectric element may be formed on the lower electrode. More specifically, the piezoelectric element may be disposed to correspond to the pressure chamber 220. Here, a length and a width of the piezoelectric element may be the same as or greater than the length and the width of the pressure chamber. The upper electrode may be formed on the piezoelectric element. Here, a size of the upper electrode may be the same as or smaller than a size of the piezoelectric element. The actuator 140 configured as described above may generate driving force by deforming the piezoelectric element through a current signal supplied through the lower electrode and the upper electrode.

Since the inkjet print head 100 configured as described above has a structure in which the first filter 310 and the second filter 320 are connected to each other, the strength of the filters 310 and 320 may be sufficiently ensured, even when the thickness of the vibration substrate 130 and the thickness of the channel forming substrate 120 are significantly decreased. Therefore, a phenomenon in which the filters 310 and 320 are damaged by an external impact or excessive vibrations of the vibration substrate 130 may be significantly decreased.

Hereinafter, other embodiments of the present invention will be described. For reference, in a description of the following embodiments, the same reference numerals will be used to describe the same components as those of the first embodiment and a detailed description of these components will be omitted.

An inkjet print head according to a second embodiment of the present invention will be described with reference to FIGS. 4 through 6.

The inkjet print head 100 according to the present embodiment may be different from the inkjet print head 100 of the above-described embodiment in terms of configurations of the first filter 310 and the second filter 320.

In the present embodiment, the first filter 310 and the second filter 320 may have different sizes and arrangements. For example, the first filter 310 may include a plurality of first holes having a first size D1 as shown in FIG. 5. Here, the first holes may be arranged in a plurality of rows (based on an X-Y plane) according to the size D1 and a size of an ink inlet (not shown) and an interval between the first holes may be a first interval S1.

Unlike this, the second filter 320 may include a plurality of second holes having a second size D2, smaller than the first size D1 as shown in FIG. 6. Here, the second holes may be arranged in a plurality of rows (based on an X-Y plane) according to the size D2 and the size of the ink inlet (not shown) and an interval between the second holes may be a second interval S2, smaller than the first interval 51. Meanwhile, the first size D1 and the first interval S1 of the first holes included in the first filter 310 may be determined such that the first holes partially intersect the second holes included in the second filter 320.

The inkjet print head 100 configured as described above may maximize an effect of removing the foreign objects by the first filter 310 and the second filter 320. In addition, since the inkjet print head 100 according to the present embodiment has a structure in which the first filter 310 and the second filter 320 partially intersect each other to be supported by each other, a phenomenon in which the first filter 310 is damaged may be alleviated even when the thickness of the vibration substrate 130 is decreased.

An inkjet print head according to a third embodiment of the present invention will be described with reference to FIGS. 7 and 9.

The inkjet print head 100 according to the present embodiment may be different from the inkjet print head 100 of the above-described embodiments in terms of shapes of the first filter 310 and the second filter 320.

In the present embodiment, the first filter 310 may include first grooves extended to be elongated in an X axis direction as shown in FIG. 8. The first grooves may be grooves each having a roughly rectangular shape having a first length L1 and a first width W1, and may be arranged at a predetermined interval in the X axis direction. Here, a first interval between the first grooves may be S1.

Unlike this, the second filter 320 may include second grooves extended to be elongated in a Y axis direction as shown in FIG. 9. The second grooves may be grooves each having a roughly rectangular shape having a second length L2 and a second width W2, and may be arranged at a predetermined interval in the X axis direction. Here, a second interval between the second grooves may be S2.

The inkjet print head 100 configured as described above include the first filter 310 and the second filter 320 having the rectangular shape, whereby the filters may be easily processed.

An inkjet print head according to a fourth embodiment of the present invention will be described with reference to FIGS. 10 through 13.

The inkjet print head 100 according to the present embodiment may be different from the inkjet print head 100 of the above-described embodiments, in that the inkjet print head 100 includes three filters 310, 320, and 330. To this end, the channel forming substrate 120 may include a first channel forming substrate 122 and a second channel forming substrate 124. More specifically, the first filter 310 may be formed in the vibration substrate 130, the second filter 320 may be formed in the second channel forming substrate 124, and the third filter 330 may be formed in the first channel forming substrate 122.

Here, a size D1 of a first hole included in the first filter 310 and a first interval S1 between the first holes, a size D2 of a second hole included in the second filter 320 and a second interval S2 between the second holes, and a size D3 of a third hole included in the third filter 330 and a third interval S3 between the third holes may be different from one another.

For reference, the first hole may be greater than the second hole and the third hole, and the second hole may be greater than the third hole in the accompanying drawings. In addition, the first interval S1 may be greater than the second interval S2 and the third interval S3, and the second interval S2 may be greater than the third interval S3. However, since this is merely an exemplary form, this may be changed to different configurations.

An inkjet print head according to a fifth embodiment of the present invention will be described with reference to FIGS. 14 through 17.

The inkjet print head 100 according to the present embodiment may be different from the inkjet print head 100 of the fourth embodiment in terms of shapes of the filters 310, 320, and 330. More specifically, the filters 310, 320, and 330 may have a groove shape extended to be elongated in one direction. Here, a size (a length L1 and a width W1) and an interval of first grooves included in the first filter 310 may be the same as those of the first grooves according to the third embodiment, and a size (a length L2 and a width W2) and an interval of second grooves included in the second filter 320 may be the same as those of the second grooves according to the third embodiment.

Meanwhile, third grooves included in the third filter 330 may have a rectangular shape extended in the same direction (an X axis direction) as that of the first grooves. Further, the third grooves may extend to be elongated in a third direction (for example, a diagonal direction). However, a size (a length L3 and a width W3) and an interval of the third grooves may be substantially the same as those of the second grooves.

The inkjet print head 100 configured as described above according to the fourth and fifth embodiments may have the three filters 310, 320, and 330 disposed to intersect one another, whereby the effect of removing foreign objects by the filters may be maximized. In addition, since portions of the filters 310, 320, and 330 are supported by the filter positioned at a lower portion of the inkjet print head, the strength of the portions of the filters 310, 320, and 330 may be improved.

Therefore, according to the present embodiment, the thicknesses of the vibration substrate 130 and the channel forming substrates 120, 122, and 124 may be significantly decreased, whereby the thinning of the inkjet print head 100 may be effectively achieved.

As set forth above, since the strength of the filters may be improved, a phenomenon in which the filters are damaged or deformed by external impacts may be alleviated.

Further, since the present invention is not restricted by formation of the filters, the inkjet print head may be thinned.

While the present invention has been shown and described in connection with the embodiments, it will be apparent to those skilled in the art that modifications and variations can be made without departing from the spirit and scope of the invention as defined by the appended claims.

What is claimed is:

1. An inkjet print head, comprising:
a vibration substrate including a first filter formed therein; and
a channel forming substrate including a second filter and a pressure chamber formed therein, the second filter being connected to the first filter.

2. The inkjet print head of claim 1, wherein the first filter and the second filter have the same shape.

3. The inkjet print head of claim 1, wherein the first filter includes a plurality of first grooves extended to be elongated in a first direction, and
the second filter includes a plurality of second grooves extended to be elongated in a second direction.

4. The inkjet print head of claim 3, wherein the plurality of first grooves and the plurality of second grooves are disposed to intersect one another.

5. The inkjet print head of claim 1, wherein the first filter includes a plurality of first holes having a first size, and
the second filter includes a plurality of second holes having a second size.

6. The inkjet print head of claim 1, wherein the vibration substrate has a thickness of 1.3 μm or less.

7. The inkjet print head of claim 1, further comprising a nozzle forming substrate including a restrictor and a nozzle formed therein,
wherein the restrictor connects the first filter and the pressure chamber, and
the nozzle is connected to the pressure chamber.

8. An inkjet print head, comprising:
a vibration substrate including a first filter formed therein;
a first channel forming substrate including a second filter formed therein, the second filter being connected to the first filter; and
a second channel forming substrate including a third filter formed therein, the third filter being connected to the second filter.

9. The inkjet print head of claim 8, wherein at least one pair of the first filter, the second filter, and the third filter has the same shape.

10. The inkjet print head of claim 8, wherein the first filter, the second filter, and the third filter have different shapes.

11. The inkjet print head of claim 8, wherein the first filter includes a plurality of first grooves extended to be elongated in a first direction, and
the second filter includes a plurality of second grooves extended to be elongated in a second direction.

12. The inkjet print head of claim 11, wherein the plurality of first grooves and the plurality of second grooves are disposed to intersect one another.

13. The inkjet print head of claim 11, wherein the third filter includes a plurality of third grooves extended to be elongated in the first direction.

14. The inkjet print head of claim 11, wherein the third filter includes a plurality of third grooves extended to be elongated in a third direction.

15. The inkjet print head of claim 8, wherein the first filter includes a plurality of first holes having a first size,
the second filter includes a plurality of second holes having a second size, and
the third filter includes a plurality of third holes having a third size.

16. The inkjet print head of claim 15, wherein the first holes, the second holes and the third holes have different sizes.

17. The inkjet print head of claim 8, wherein the vibration substrate has a thickness of 1.3 μm or less.
